(19) United States
(12) Patent Application Publication
(10) Pub. No.: US 2016/0039717 A1
(43) Pub. Date: Feb. 11, 2016

(54) POLYCRYSTALLINE TRANSPARENT CERAMICS LAMINATE

(71) Applicant: JEN LONG VACUUM INDUSTRIAL CO., LTD., HSINCHU COUNTY (TW)

(72) Inventor: Rong-Fu WU, HSINCHU CITY (TW)

(21) Appl. No.: 14/456,451

(22) Filed: Aug. 11, 2014

(51) Int. Cl. C04B 35/10

(52) U.S. Cl. CPC C04B 35/10

(57) ABSTRACT

A polycrystalline transparent ceramics laminate includes a polycrystalline ceramics laminate made of polycrystalline transparent ceramics. The polycrystalline transparent ceramics contains aluminum oxide. The polycrystalline ceramics laminate may have flat, curved, or spherical surfaces. The polycrystalline ceramics laminate has a top and a bottom opposite to the top. The polycrystalline transparent ceramics laminate has a density greater than 3.5 g/cm³, a surface roughness smaller than or equal to 1 μm, a transparency at a thickness of 1 mm greater than or equal to 60%, and a refractive index between 1.5 and 2.5.

### BACKGROUND OF THE INVENTION

1. Technical Field

The present invention relates to display devices, and more particularly to a polycrystalline transparent ceramics laminate.

2. Description of Related Art

LCD devices have been extensively used in various handheld apparatuses. For preventing LCD devices from being damaged by impacts or scrapes, a protective layer is typically provided on the surface of the LCD devices. Traditionally, the protective layer is a layer of enhanced (reinforced) glass. With the progressive of manufacturing capability, monocrystalline sapphire laminate is used as an emerging material of the protective layer. Monocrystalline sapphire laminate is known to be very hard and highly pervious to light, and thus provides better protective effects as compared with enhanced (reinforced) glass. However, the use of monocrystalline sapphire laminate has its defects. Particularly, monocrystalline sapphire laminate is made by cutting columnar monocrystalline and grinding it. For producing non-flat sapphire laminate, such as sapphire laminate with curved or spherical surfaces, the process requires cutting large-size bulk crystal and grinding it into a three-dimensional shape, thus being highly time-consuming and material-wasting. Moreover, since monocrystalline features that different parts across the entire crystal share the common physical properties, the resulting laminate can only have fixed transparency that is not adjustable. This imposes limitation to the laminate's polarizing effects, making the single crystal rigid in terms of application.

### SUMMARY OF THE INVENTION

In view of the shortcomings of the prior-art devices, one objective of the present invention is to provide a polycrystalline transparent ceramics laminate that requires less processing time and prevents waste of materials.

Another objective of the present invention is to provide a polycrystalline transparent ceramics laminate that may be formed into a three-dimensional shape.

For achieving the foregoing objectives, the disclosed polycrystalline transparent ceramics laminate comprises a polycrystalline ceramics laminate made of polycrystalline transparent ceramics that contains aluminum oxide. The polycrystalline ceramics laminate has a top and a bottom opposite to the top. The polycrystalline transparent ceramics laminate has a density greater than 3.5 g/cm³, a surface roughness smaller than or equal to 1 μm, a transparency at a thickness of 1 mm greater than or equal to 60%, and a refractive index between 1.5 and 2.5.

### BRIEF DESCRIPTION OF THE DRAWINGS

FIG. 1 depicts a first embodiment of the present invention.

FIG. 2 depicts a second embodiment of the present invention.

FIG. 3 depicts a third embodiment of the present invention.

### DETAILED DESCRIPTION OF THE INVENTION

The following preferred embodiments when read with the accompanying drawings are made to clearly exhibit the above-mentioned and other technical contents, features and effects of the present invention. Unless otherwise noted, like elements will be identified by identical numbers throughout all figures.

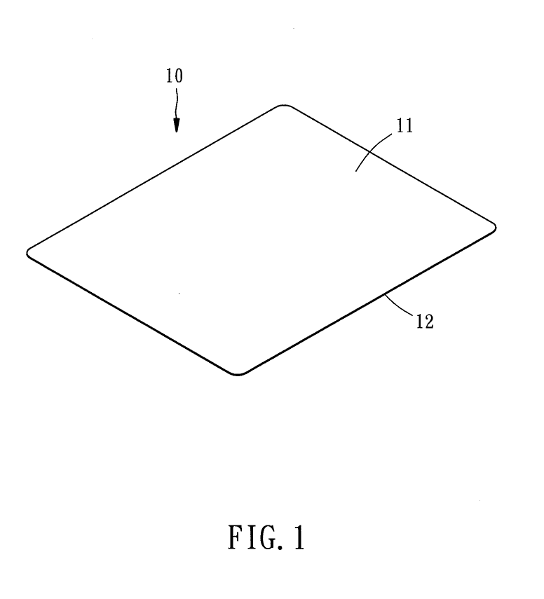

Referring to FIG. 1, according to the present invention, a polycrystalline transparent ceramics laminate comprises the following configuration.

A polycrystalline ceramics laminate (10) is made of polycrystalline transparent ceramics. The polycrystalline transparent ceramics contains aluminum oxide. In the polycrystalline transparent ceramics laminate, the crystals are aligned along at least two different axes. The polycrystalline ceramics laminate (10) has a top (11) and a bottom (12) opposite to the top (11). The polycrystalline ceramics laminate (10) has a density greater than 3.5 g/cm³, a surface roughness smaller than or equal to 1 μm, a transparency at a thickness of 1 mm greater than or equal to 60%, and a refractive index between 1.5 and 2.5.

In the first embodiment of the present invention, the polycrystalline transparent ceramics laminate is a flat board and the top (11) and the bottom (12) are two parallel planes.

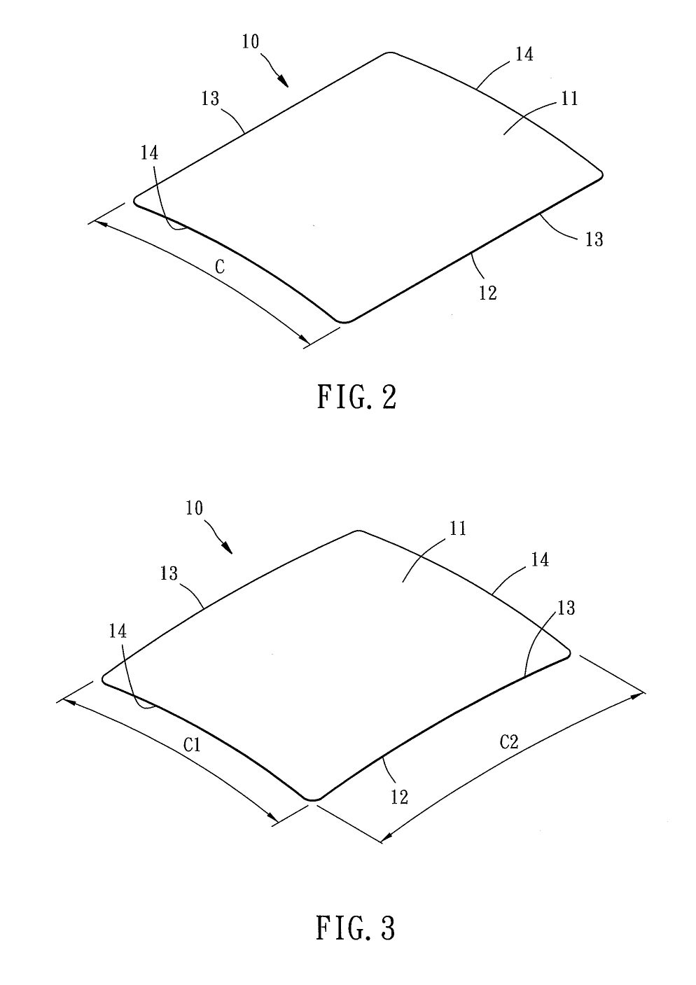

As shown in FIG. 2, in a second embodiment of the present invention, the polycrystalline transparent ceramics laminate comprises a polycrystalline ceramics laminate (10), made of polycrystalline transparent ceramics that contains aluminum oxide. The polycrystalline ceramics laminate (10) being of a lengthwise shape has a top (11) and a bottom (12) opposite to the top (11). The polycrystalline ceramics laminate has a density greater than 3.5 g/cm³, a surface roughness smaller than or equal to 1 μm, a transparency at a thickness of 1 mm greater than or equal to 60%. The polycrystalline ceramics laminate (10) has two opposite long edges (13) and two opposite short edges (14). The polycrystalline ceramics laminate bends from one said long edge (13) toward the other long edge (13), so that the top (11) and the bottom (12) are curved to the same side, thereby defining a radian C on the minor axis, as shown in the drawing, so that the polycrystalline ceramics laminate has a single-axis curved surface.

Referring to FIG. 3, in a third embodiment of the present invention, the polycrystalline transparent ceramics laminate comprises a polycrystalline ceramics laminate (10) made of polycrystalline transparent ceramics. The polycrystalline transparent ceramics contains aluminum oxide. The polycrystalline ceramics laminate (10) is of a lengthwise shape having a top (11) and a bottom (12) opposite to the top (11). The polycrystalline ceramics laminate has a density greater than 3.5 g/cm³, a surface roughness smaller than or equal to 1 μm, a transparency at a thickness of 1 mm greater than or equal to 60%. The polycrystalline ceramics laminate (10) has two opposite long edges (13) and two opposite short edges (14). The polycrystalline ceramics laminate (10) bends from one said long edge (13) toward the other long edge (13), so that the top (11) and the bottom (12) are curved to the same side, thereby defining a first radian C1 on the minor axis, as shown in the drawing. The polycrystalline ceramics laminate (10) bends from one said short edge (14) toward the other short edge (14), thereby defining a second radian C2 on the major axis, as shown in the drawing. The first radian C1 and the second radian C2 may be identical or different, so that the polycrystalline ceramics laminate is formed as a three-dimensional multi-bending laminate.

Since the disclosed ceramics laminate is made of polycrystalline instead of monocrystalline, it is more structurally adjustable as compared with monocrystalline laminate. The choice of material also determines the spectral distribution when light comes in. Therefore, the disclosed polycrystalline transparent ceramics laminate, as compared with monocrystalline sapphire laminate, is more favorable to the provision of desired spectral distributions.

Furthermore, the disclosed polycrystalline transparent ceramics laminate may be manufactured through powder consolidation, compression molding, powder injection molding, slip casting or plastic molding into a one-piece single-bending or multi-bending three-dimensional laminate. Opposite to the conventional monocrystalline sapphire laminate that requires cutting large-size bulk crystal and grinding it into a three-dimensional shape, the present invention is helpful to save costs and reduce processing time.

What is claimed is:

1. A polycrystalline transparent ceramics laminate, comprising:
a polycrystalline ceramics laminate, being made of polycrystalline transparent ceramics that contains aluminum oxide, and having a top and a bottom opposite to the top, the polycrystalline ceramics laminate having a density greater than 3.5 g/cm³, a surface roughness smaller than or equal to 1 μm, a transparency at a thickness of 1 mm greater than or equal to 60%, and a refractive index between 1.5 and 2.5.

2. The polycrystalline transparent ceramics laminate of claim 1, wherein crystals in the polycrystalline ceramics laminate are aligned at least two different axes.

3. The polycrystalline transparent ceramics laminate of claim 1, wherein the polycrystalline ceramics laminate is of a lengthwise shape having two opposite long edges and two opposite short edges, the polycrystalline ceramics laminate bending from one said long edge toward the other long edge so that the top and the bottom are curved to an identical side, thereby defining a radian on a minor axis of the laminate, so that the polycrystalline ceramics laminate has a single-axis curved surface.

4. The polycrystalline transparent ceramics laminate of claim 2, wherein the polycrystalline ceramics laminate is of a lengthwise shape having two opposite long edges and two opposite short edges, the polycrystalline ceramics laminate bending from one said long edge toward the other long edge so that the top and the bottom are curved to an identical side, thereby defining a radian on a minor axis of the laminate, so that the polycrystalline ceramics laminate has a single-axis curved surface.

5. The polycrystalline transparent ceramics laminate of claim 1, wherein the polycrystalline ceramics laminate is of a lengthwise shape having two opposite long edges and two opposite short edges, the polycrystalline ceramics laminate bending from one said long edge toward the other long edge so that the top and the bottom are curved to an identical side, thereby defining a first radian on a minor axis of the laminate, the polycrystalline ceramics laminate also bending from one said short edge toward the other short edge, thereby defining a second radian on a major axis of the laminate, so that the polycrystalline ceramics laminate is formed as a three-dimensional multi-bending laminate.

6. The polycrystalline transparent ceramics laminate of claim 5, wherein the first radian is identical to the second radian.

7. The polycrystalline transparent ceramics laminate of claim 5, wherein the first radian is different from the second radian.

8. The polycrystalline transparent ceramics laminate of claim 2, wherein the polycrystalline ceramics laminate is of a lengthwise shape having two opposite long edges and two opposite short edges, the polycrystalline ceramics laminate bending from one said long edge toward the other long edge so that the top and the bottom are curved to an identical side, thereby defining a first radian on a minor axis of the laminate, and the polycrystalline ceramics laminate also bending from one said short edge toward the other short edge, thereby defining a second radian on a major axis of the laminate, so that the polycrystalline ceramics laminate is formed as a three-dimensional multi-bending laminate.

9. The polycrystalline transparent ceramics laminate of claim 8, wherein the first radian is identical to the second radian.

10. The polycrystalline transparent ceramics laminate of claim 8, wherein the first radian is different from the second radian.
